(19) United States
(12) Patent Application Publication
(10) Pub. No.: US 2025/0094782 A1
(43) Pub. Date: Mar. 20, 2025

(54) STOCHASTIC SOIL PROPERTY MODELING VIA DEEP NEURAL NETWORKS

(71) Applicant: Schlumberger Technology Corporation, Sugar Land, TX (US)

(72) Inventors: Haibin Di, Houston, TX (US); Aria Abubakar, Houston, TX (US)

(21) Appl. No.: 18/886,329

(22) Filed: Sep. 16, 2024

Related U.S. Application Data
(60) Provisional application No. 63/582,912, filed on Sep. 15, 2023.

(51) Int. Cl. G06N 3/0464; G01V 1/28

(52) U.S. Cl. CPC G06N 3/0464; G01V 1/282

(57) ABSTRACT

Certain aspects are directed to a method for estimating subsurface properties. The method may generally include receiving seismic data associated with a subsurface region; incorporating noise into the seismic data to create modified seismic data; inputting the modified seismic data into a machine-learning model configured to output a predicted subsurface property; obtaining from the machine-learning model, the predicted subsurface property, wherein the predicted subsurface property is based on the modified seismic data; and deriving an associated measure of uncertainty for the predicted subsurface property, wherein the predicted subsurface property is associated with the subsurface region.

### CROSS-REFERENCE TO RELATED APPLICATIONS

This application claims the benefit of and priority to U.S. Provisional Patent Application No. 63/582,912 filed on Sep. 15, 2023, the entire contents of which are herein incorporated by reference.

### BACKGROUND

### Field

Aspects of the present disclosure relate to methods and systems for subsurface characterization, and in particular, to the accurate estimation of subsurface properties for offshore site screening.

### Description of Related Art

The efficient development and operation of offshore structures, such as offshore windfarms, necessitate careful evaluation of potential site locations. Accurate characterization of near-subsurface soil properties, such as cone-tip resistance (RES), friction/resistance of the sleeve (FRES), and pore-water pressure (PWP), is beneficial in this evaluation process, as it directly impacts the design and stability of wind turbine foundations and can influence the overall efficiency and cost-effectiveness of wind energy projects. Traditional methods for subsurface characterization often rely on a combination of geotechnical investigations, primarily cone-penetration tests (CPT), and geophysical surveys, such as seismic techniques. While these methods have provided valuable insights, they often suffer from limitations that hinder their effectiveness in delivering precise and comprehensive near-subsurface soil property estimations.

### SUMMARY

Certain aspects provide a method for estimating subsurface properties. In some aspects, the method comprises: receiving seismic data associated with a subsurface region; incorporating noise into the seismic data to create modified seismic data; inputting the modified seismic data into a machine-learning model configured to output a predicted subsurface property; obtaining from the machine-learning model, the predicted subsurface property, wherein the predicted subsurface property is based on the modified seismic data; and deriving an associated measure of uncertainty for the predicted subsurface property, wherein the predicted subsurface property is associated with the subsurface region.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a workflow for performing stochastic estimation of subsurface properties in accordance with examples of the present disclosure.

FIG. 2 depicts additional details directed to generating augmented seismic data and prior models in accordance with examples of the present disclosure.

FIG. 3 depicts an example workflow of a training process used for stochastic estimation of subsurface properties in accordance with examples of the present disclosure.

FIG. 4 depicts an example of the inference process for estimating subsurface properties from seismic data using a stochastic approach in accordance with examples of the present disclosure.

FIG. 5 depicts a multi-task convolutional neural network (CNN) architecture configured to predict multiple subsurface properties from seismic data stacks and additional contextual data in accordance with examples of the present disclosure.

FIG. 6 depicts an example layout of ultra-high-resolution (UHR) seismic lines and CPT locations at an offshore location in accordance with examples of the present disclosure.

FIG. 7 depicts example performance validations using a trained CNN model for near-subsurface soil properties estimations in accordance with examples of the present disclosure.

FIG. 8 depicts example CNN model predictions along UHR seismic lines in three-dimensions (3D) in accordance with examples of the present disclosure.

FIG. 9 depicts an example method for performing estimation of subsurface properties in accordance with examples of the present disclosure.

FIG. 10 depicts an example method for training a machine-learning model to perform stochastic estimation of subsurface properties.

FIG. 11 depicts an example processing system configured to perform various aspects described herein in accordance with examples of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Wind energy has emerged as a pivotal source of renewable power generation, leading to rapid advancements in windfarm development. To harness the full potential of wind energy, the selection of suitable offshore windfarm sites requires a careful assessment, particularly of subsurface properties. Subsurface properties refer to the characteristics and attributes of the soil and/or rock located within the upper layers of the Earth's crust, typically within a depth range of a few meters to several tens of meters below the ground surface. Subsurface properties may directly influence the design and stability of wind turbine foundations, consequently affecting the efficiency and cost-effectiveness of wind energy projects.

Historically, the characterization of subsurface properties for site evaluations, such as windfarm sites, has relied on a combination of geotechnical investigations, primarily cone-penetration tests (CPT), and geophysical surveys, which may include seismic techniques. While CPT provides valuable data, CPT is often limited in spatial coverage due in part to the impracticality of deploying CPT at locations throughout a test site; the discrete nature of CPT measurement points makes it challenging to create comprehensive near-subsurface models. Seismic exploration techniques have been widely employed to address these limitations and provide a more holistic view of subsurface properties. Seismic surveys generally involve the generation of acoustic waves or vibrations that travel through the near subsurface. By analyzing the reflections and refractions of these waves, geophysicists and geologists can infer the characteristics of subsurface layers and structures. Two-dimensional (2D) and three-dimensional (3D) seismic surveys have allowed for detailed imaging of subsurface structures. However, the direct estimation of geotechnical properties from seismic data remains a complex challenge.

Several approaches have been proposed to bridge the gap between seismic data and subsurface property estimation. For example, a practical and effective approach involves the integration of two-dimensional (2D) ultra-high-resolution (UHR) seismic data with CPT results, utilizing techniques such as seismic inversion, attribute analysis, and geostatistical mapping methods. Notably, machine-learning algorithms, including random forest and artificial neural networks, have demonstrated promise in improving the accuracy of subsurface estimations by leveraging multi-dimensional data. These machine-learning algorithms hold significant potential for streamlining the subsurface characterization process and reducing associated costs.

However, despite the existence of deep learning models, they are not without their technical challenges. One significant technical problem to overcome includes their propensity to heavily rely on training labels, which becomes problematic when actual subsurface property measurements are scarce and are typically confined to sparse CPT locations. This over-dependence on labeled training data increases the risk of overfitting and introduces inaccuracies into subsurface property estimations. Another substantial technical problem to overcome lies in the current inability of existing subsurface characterization techniques to provide uncertainty analysis. The absence of comprehensive uncertainty quantification restricts the practical utility of machine learning model predictions in subsequent site characterization tasks, including the development of ground models, risk assessment, and optimization of foundation design.

Thus, while existing methods have shown promise, they often may utilize significant computational resources, calibration, and validation, and may not fully capture the complexity of near-subsurface soil properties. Furthermore, they often lack robust uncertainty analysis, limiting their utility in risk assessment and decision-making processes related to subsurface engineering projects. In light of these challenges, there exists a need to increase the reliability and accuracy of subsurface characterization for offshore site selections, such as offshore windfarms.

Embodiments described herein overcome the aforementioned technical problems and improve upon the state of the art with beneficial technical effects by performing stochastic estimation of subsurface properties to improve the precision and confidence in subsurface properties estimations, which may then be used to make informed decisions when performing offshore site selections, such as offshore windfarm developments. Aspects of the present disclosure provide apparatuses, methods, processing systems, and computer-readable mediums for utilizing CNN-based workflows to enable stochastic estimation of subsurface properties from UHR seismic data and log data, such as CPT logs. More specifically, a series of prior models of subsurface properties may be generated from available log data (e.g., CPT logs). The series of prior models, together with UHR seismic data, may then be utilized to train a CNN model to estimate subsurface properties and their associated posterior uncertainty, where posterior uncertainty refers to the uncertainty or lack of certainty associated with the estimated subsurface properties when, based on for example, seismic data. The use of the fractal-based prior models enrich the training label and correspondingly reduce risks of overfitting, especially when the available CPT measurements are limited in space and/or quantity. In other words, CPT measurements are usually sparsely distributed across a unit area. For instance, the number of CPT measurements at a specific test site may be limited and potentially be below a certain threshold or unit of measurement. In some examples, the UHR seismic data may be augmented with noise or other transformations to increase the diversity of the UHR seismic dataset and to improve the CNN model's ability to generalize to real-world scenarios. Examples discussed herein provide an improvement to a technical problem within the specific technical environment of subsurface evaluations. In addition to predicting subsurface properties, examples of the present disclosure can be readily extended to other tasks, such as rock property estimations during surface and subsurface exploration, development, construction, and production activities.

### Example Workflow for Stochastic Estimation of Multiple Subsurface Properties

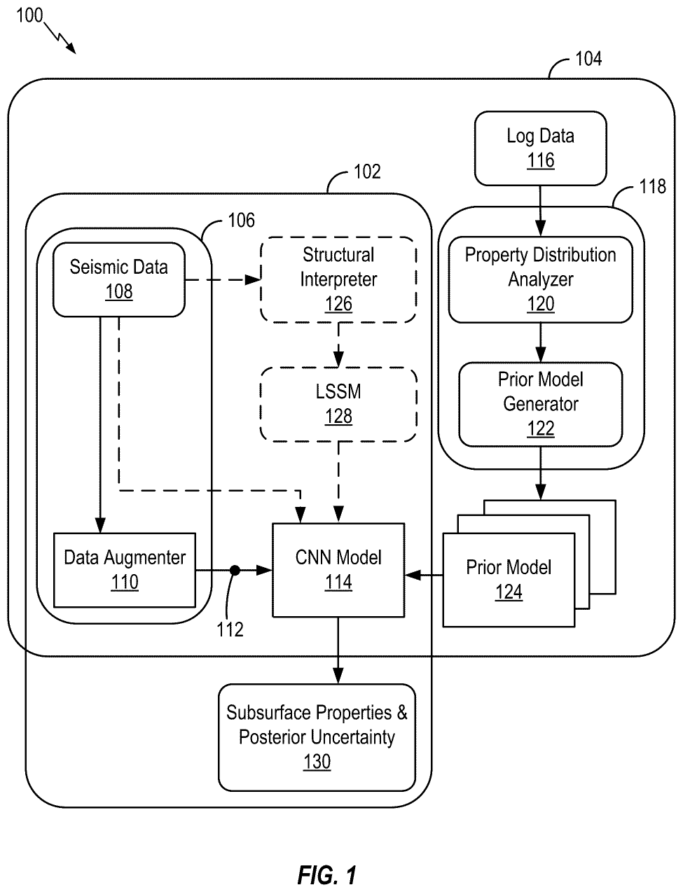

FIG. 1 illustrates an example workflow 100 for performing stochastic estimation of subsurface properties using machine-learning techniques, in accordance with aspects of the present disclosure. In some aspects, workflow 100 integrates seismic data 108 and well log data 116 to train and utilize a convolutional neural network (CNN) model 114 for predicting subsurface properties and their associated uncertainties. Workflow 100 includes both an inference workflow 102 and a training workflow 104, which together process input data to generate accurate estimations of subsurface properties.

In some aspects, techniques are described that relate to the use of deep learning models, for example, a CNN model 114, for subsurface property estimation. In some aspects, a training workflow 104 involves generating training labels from available log data 116, such as CPT logs, and prior models 124 that simulate the geotechnical properties of the subsurface. In some aspects, the prior models 124 may be constructed using fractal-based techniques or other probabilistic methods to account for spatial variability and uncertainty in the subsurface environment. The resulting training labels, which may include subsurface properties such as cone resistance RES, FRES, and PWP, may be aligned with seismic data 108 to form a dataset that serves as the basis for training the CNN model 114.

Once the training labels have been generated, the CNN model 114 may be trained using UHR seismic data, which is augmented and preprocessed to improve model generalization and robustness. The CNN model 114 learns to map the seismic data 108 to the corresponding training labels generated from log data 116, enabling the prediction of subsurface properties directly from seismic data 108. The combination of log data-derived labels and seismic data 108 enables the CNN model 114 to estimate subsurface properties, including soil and rock characteristics, across a broader region, even in areas where direct measurements are sparse. The training workflow 104 results in a trained CNN model 114 model capable of predicting subsurface properties with associated uncertainty, which can be used in further geological and geotechnical studies.

In some embodiments, workflow 100 is implemented via a cloud-based AI platform.

An AI platform may include an integrated set of technologies that allow for the developing, testing, deploying, and/or refreshing of machine learning models. The AI platform used to implement workflow 100 may integrate data ingestion, pre-processing, modeling, and/or, in some cases, visualization, in a single environment. Further, the AI platform may allow for real-time project sharing, thereby facilitating seamless collaboration among users when performing near-subsurface soil property characterizations for one or more offshore sites. As such, implementation of workflow 100 via the AI platform provides significant technical advantages that address the challenge of training CNN-based models and performing inference operations when conducting stochastic estimations of multiple near-subsurface soil properties.

While workflow 100 is not limited to a specific scenario, an example is described in which the CNN model 114 is trained (e.g., training workflow 104) to predict multiple subsurface properties (e.g., near-subsurface soil properties, rock properties) using data from seismic surveys and well log data 116. Once trained, the CNN model 114 performs inference operations (e.g., inference workflow 102) to estimate subsurface properties using newly acquired seismic data 108. This workflow can be used to evaluate and influence the design and stability of subsurface foundations, such as wind turbine foundations, by efficiently obtaining various subsurface properties.

In some aspects, the training workflow 104 begins with a seismic data processor 106, which receives seismic data 108 from a subsurface region of interest. In examples, seismic data 108 can be UHR seismic data and can refer to a specialized type of seismic data acquisition that is characterized by its high spatial resolution and the ability to capture fine details and small-scale geological features in the subsurface. UHR seismic data is typically used in geophysical and geological studies to gain a detailed understanding of the Earth's subsurface structures and properties. UHR seismic data can include a broad range of high frequencies, often extending into the kilohertz (kHz) or megahertz (MHz) range. This high-frequency content allows for the detection of subtle subsurface variations and at vertical sampling rates that range from fractions of a millimeter to several centimeters or more. In examples, UHR seismic data includes a matrix of seismic traces, each representing the recorded ground motion at a specific sensor location and point in time. More specifically, each trace may include amplitude values representing the recorded ground motion at each time or sample point, where each amplitude value can indicate how much the ground moved or vibrated at the location of the sensor in response to the passing seismic waves. Additionally, UHR seismic data may include header information detailing metadata, such as survey location, acquisition parameters (e.g., water temperature, surface weather, etc.), sensor specifications (e.g., sensor type, calibration information, etc.), and source characteristics (e.g., properties and attributes of the seismic source used to generate the seismic waves that propagate through the subsurface and are recorded by the seismic sensors, such as but not limited to energy levels, frequency content, etc.).

The seismic data processor 106 may align the seismic data 108 with other available geological information to ensure consistency across data sources, improving the accuracy of subsurface property estimations. This alignment helps correlate the seismic data 108 both spatially and temporally with other inputs. The seismic data processor 106 may apply one or more preprocessing steps such as noise reduction, amplitude normalization, and other signal processing techniques to enhance data quality.

While seismic data 108 can further be enhanced through processing techniques, e.g., to remove noise and emphasize subtle subsurface reflections and refractions, one or more data augmentation techniques may be applied at for purposes of assisting a CNN model's 114 ability to generalize. More specifically, because the seismic data 108 is being provided to the CNN model 114, noise can be added to seismic data 108 to increase the diversity of the dataset and improve the CNN model's 114 ability to generalize to real-world scenarios. Noise helps prevent overfitting and enhances the CNN model's 114 robustness by exposing the CNN during training to a wider range of variations that it might encounter during actual deployment. That is, the data augmenter 110 may apply data augmentation techniques, such as adding noise, to improve the CNN model 114's generalization. For instance, Gaussian noise may be incorporated into the seismic data 108 to increase dataset diversity and prevent overfitting. The data augmenter 110 may also apply random rotations, scaling, or cropping to create a varied set of training examples. The result of the data augmenter 110 can then be provided to the CNN model 114 during a training workflow 104 and/or an inference workflow 102.

In some aspects, the training workflow 104 includes the use of log data 116, prior models 124, and seismic data 108. The log data 116, such as CPT logs, provides direct measurements of subsurface soil properties, like RES, FRES, and PWP. Log data 116, may include CPT logs that may be obtained through a geotechnical field investigation technique used to assess the properties of subsurface soils and stratigraphy. During a CPT, a specialized instrument known as a cone penetrometer, typically mounted on a mobile platform or rig, is vertically advanced into the ground at a controlled rate. The cone penetrometer consists of a conical tip, a series of sensors to measure RES and FRES, and sometimes PWP. As the cone penetrometer is pushed into the ground, it continuously records these measurements at predefined depth intervals.

In examples, the CPT data can be obtained at specific sampling rates and spatial resolutions. The sampling rate can refer to how frequently measurements are recorded or sampled as the cone penetrometer is advanced into the ground. The sampling rate can vary depending on the specific equipment used and the needs of the geotechnical investigation. In many CPT systems, data is typically recorded at a rate of 1 to 10 samples per second (Hz). In some examples, CPT sampling may occur at specific spatial resolutions or intervals at which measurements are recorded along the depth of the CPT probe's penetration into the ground, which is also referred to as a vertical sampling rate. Utilizing the log data 116, one or more prior models 124 can be generated and provided to the CNN model 114 as part of training workflow 104.

Upon obtaining the log data 116, the log processor 118 may preprocess the log data 116 to ensure it is depth-aligned and quality-checked to ensure consistency with the seismic data 108. In some aspects, the property distribution analyzer 120 processes the pre-processed log data to determine the statistical properties and spatial patterns of subsurface characteristics. For instance, the property distribution analyzer 120 may evaluate how geotechnical properties such as RES, FRES, and PWP vary spatially across different regions and depths. This analysis may aid in understanding the underlying variability in subsurface properties, which may be used to generate and/or select one or more prior models 124.

Based on the statistical analysis from the property distribution analyzer 120, the prior model generator 122 creates or selects prior models 124. In some aspects, the prior models 124 represent probabilistic estimates of subsurface properties (e.g., soil characteristics, porosity, permeability, and rock type) across areas where direct measurements from log data 116 are unavailable or sparse. The prior models 124 may account for spatial variability and uncertainty by employing methods such as fractal-based techniques, geostatistics, or other probabilistic approaches. These prior models 124 simulate the range of expected subsurface properties and help enrich the dataset used for training the CNN model 114.

In some aspects, the prior models 124 may be probabilistic in nature, meaning they represent a range of possible values for the subsurface properties along with associated probabilities. These models may provide initial estimates in regions with no direct measurements and serve as training labels for the CNN model 114 during the training workflow 104. That is, the CNN model 114 may be trained to map seismic data 108 to these training labels derived from both the prior models and log data 116.

In some aspects, during the training workflow 104, the CNN model 114 may be trained using a stochastic process, where multiple realizations of the input data (seismic data 108 and prior models 124) are introduced with variations, such as added noise, to improve the CNN model's 114 generalization capabilities. This stochastic training approach can help the CNN model 114 predict subsurface properties across a wide range of geological conditions while better accounting for uncertainty in the data. By exposing the CNN model 114 to different variations of input data during training, the CNN model 114 learns to account for natural variability in subsurface formations and improves its ability to generalize to new data.

After the training is complete, the inference workflow 102 enables the CNN model 114 to make predictions of subsurface properties, including soil and/or rock properties such as porosity, permeability, and rock type, using newly acquired seismic data 108. In some aspects, the predicted subsurface properties and corresponding uncertainty 130 may be the output of the CNN model 114. The CNN model 114 can directly estimate subsurface properties, such as porosity, permeability, soil composition, and rock type, based on the seismic features extracted during training. In addition to predicting these subsurface properties, the CNN model 114 is also capable of quantifying the associated uncertainty by generating multiple realizations of the predictions during inference.

The workflow 100 may also incorporate large-scale structural information through a structural interpreter 126, which extracts features from the seismic data 108, such as faults, stratigraphic boundaries, and/or salt domes. This information can then be used to generate a large-scale structure model (LSSM) 128, which may provide a broader geological context for the CNN model 114. The LSSM 128 helps CNN model's 114 predictions to align with local subsurface variations and also with larger-scale geological trends, improving the reliability and geological plausibility of the predictions.

In some aspects, once the subsurface rock properties, such as porosity, permeability, and fracture density, are estimated using the methods described herein, the estimated rock properties may be used to perform a hydrocarbon reserve estimation for a hydrocarbon reservoir, allowing for the quantification of the potential hydrocarbon resources in the subsurface region.

In some aspects, the predicted soil properties, such as soil type, compaction, and moisture content, may be further utilized to perform a foundation stability assessment, providing information to assess the suitability of subsurface conditions for supporting offshore wind turbine foundations or other subsurface structures.

In some implementations, the LSSM 128 provides structural context data that complements the seismic data 108 input into the CNN model 114. The structural context data extracted from the LSSM 128 may include spatial information about major geological features, such as fault systems, sedimentary layer boundaries, or large-scale folding structures. By inputting both the augmented seismic data 112 and the structural context data into the CNN model 114, the workflow 100 enables the CNN model 114 to generate predictions that are more geologically informed. This approach allows the CNN model 114 to account for both localized seismic variations and the broader geological framework, resulting in more accurate and coherent subsurface property predictions.

For example, in areas where seismic reflections are ambiguous or sparse, the structural context data provided by the LSSM 128 can help guide the CNN model 114 by offering a structural framework that aligns with known geological features. This helps prevent the CNN model 114 from overfitting to local variations that may not be consistent with the regional geological structure. By using both the augmented seismic data 112 and LSSM-based structural context data, the CNN model's 114 may be better aligned with the overall subsurface architecture, ultimately improving the accuracy of the final property estimations.

After the training is complete, the inference workflow 102 enables the CNN model 114 to make predictions of subsurface properties using newly acquired seismic data 108. As part of this inference process, the CNN model 114 generates multiple realizations of subsurface properties by introducing controlled variations in the input data, such as Gaussian noise or other random transformations. Each realization represents a possible outcome based on the variability in both the seismic data and the prior models 124 used during training.

By producing multiple realizations, the CNN model 114 captures the natural variability and uncertainty inherent in subsurface properties. These realizations allow the CNN model 114 to calculate posterior uncertainty estimations by analyzing the spread of the predicted properties across all realizations. For example, the variance or standard deviation of the predicted values provides a direct measure of the uncertainty associated with each estimated subsurface property. The wider the spread in the predicted values across realizations, the higher the CNN model's 114 uncertainty in that region.

This process of uncertainty quantification may be useful in areas where subsurface conditions may be highly variable or where data coverage is sparse. By quantifying the uncertainty, the CNN model 114 provides a single estimate of a property (e.g., porosity or permeability) and a range of possible values, offering insight into the confidence level of the predictions. This posterior uncertainty estimation allows decision-makers to evaluate the reliability of the model's predictions and take appropriate actions, such as focusing additional data collection efforts in areas where uncertainty is high.

For instance, if the variance in the predicted porosity values is relatively low across the realizations, this suggests that the CNN model 114 has high confidence in its estimate for that region. Conversely, a high variance in predicted permeability may indicate that more seismic or well log data is needed to reduce uncertainty. The ability to provide statistical measures of uncertainty, such as confidence intervals or standard deviations, enhances the robustness of the CNN model 114's outputs, making it easier to understand where predictions are reliable and where further investigation may be needed.

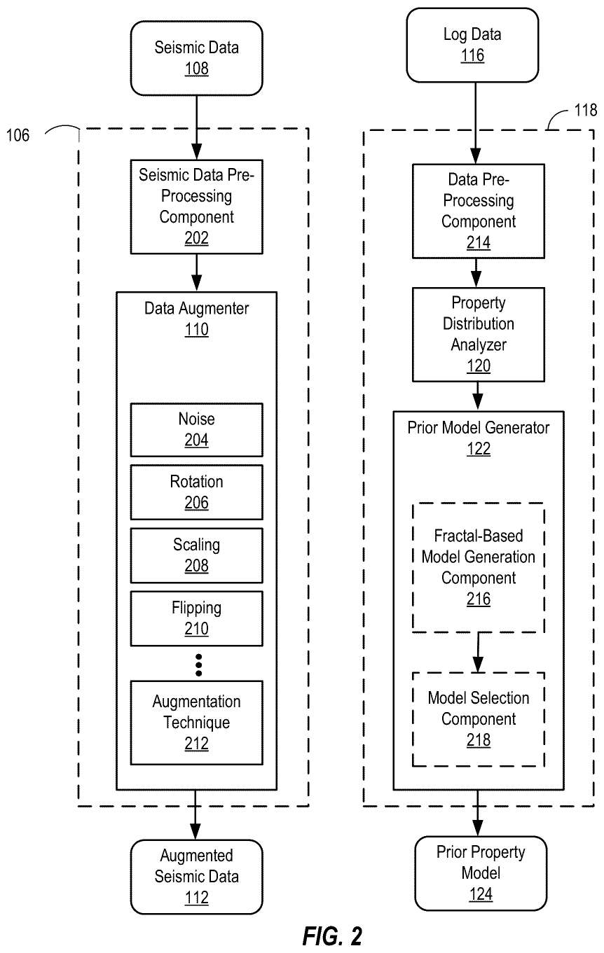

FIG. 2 depicts additional details directed to generating augmented seismic data 112 and prior models 124 in accordance with examples of the present disclosure. In examples, seismic data 108 is received at seismic data processor 106. The seismic data processor 106 can perform various types of processing, such as, but not limited to, seismic data pre-processing and data augmentation. Seismic data 108 can be received at the seismic data pre-processing component 202 and enhanced through pre-processing techniques to remove noise and emphasize subtle subsurface reflections and refractions. Further, the seismic data 108 can undergo data quality checks to identify and correct sensor-related issues, noise, or acquisition errors. Additional pre-processing steps can include time-domain corrections, such as static corrections to correct for irregular surface conditions and elevation variations, and amplitude scaling to normalize energy levels. Seismic data 108 may also be filtered to remove noise, and deconvolution can be applied to improve resolution.

The data augmenter 110 can then augment data received from the seismic data pre-processing component 202. In examples, one or more data augmentation techniques may be applied to help the CNN model 114 to generalize across real world applications. More specifically, noise augmentation 204 can be applied to the pre-processed seismic data, where noise augmentation 204 adds noise to seismic data 108. In some examples, the noise can be Gaussian noise having a mean equal to zero and a variance equal to one. In general, Gaussian noise has a probability distribution that follows a bell-shaped curve known as the Gaussian distribution or normal distribution. In this distribution, the majority of data points are clustered around a central value (the mean or average), with fewer data points as you move away from the mean in either direction. In some examples, the noise may be a type of noise other than Gaussian noise. Noise addition is just one type of data augmentation technique; others include rotation 206, scaling 208, flipping 210, cropping, or others (e.g., augmentation technique 212). The resulting data from the data augmenter 110 can then be provided to the CNN model 114 (as described above in FIG. 1) as augmented seismic data 112 for training and/or inference operations.

In examples, log data 116, such as CPT data, is received at the data pre-processing component 214. The data pre-processing component 214 can perform various types of processing, such as but not limited to CPT data pre-processing and model generation. In some examples, the log data 116 is received at the data pre-processing component 214 and is checked for sensor-related errors or anomalies, and corrections are applied to account for factors like equipment drift and temperature variations. Depth and time alignment are adjusted to ensure consistent measurements. Noisy data points may be filtered or smoothed to remove outliers, and digitization errors are corrected. Additionally, signal-processing techniques may be employed to enhance the resolution of log data 116. The pre-processed log data can be decomposed at the property distribution analyzer 120 into mean-variance curves that are matched to the vertical sampling rate of the seismic data 108. For example, log data 116 (e.g., CPT data) may be originally sampled at 2.5 cm, whereas seismic data 108 may have a vertical sampling rate of 12.5 cm. Thus, the pre-processed log data is decomposed into mean-variance curves having a vertical sampling rate equal to 12.5 cm.

In examples, the prior model generator 122 generates one or more fractal-based models. As previously discussed, the \fractal-based model may refer to a geotechnical model that combines log data 116 with fractal theory to describe and analyze the spatial variability of geotechnical properties, such as soil properties, in the subsurface. The fractal-based model can involve the development of fractal dimensions, scaling laws, and correlation functions that describe how these properties vary with depth and lateral position. By incorporating fractal principles, the fractal-based model aims to provide a more realistic representation of the sub surface's heterogeneity.

In some examples, the fractal-based model generation component 216 can apply fractal analysis techniques to pre-processed log data 116 to assess the self-similarity and spatial complexity of soil properties at different scales. Fractal analysis can be performed using methods such as the box-counting method or the Hurst exponent. Further, the fractal-based model generation component 216 can apply fractal analysis techniques to log data 116 (e.g., CPT data) to determine one or more fractal dimensions of the soil property data, where the fractal dimensions quantify the irregularity and complexity of the soil data's spatial distribution. A higher fractal dimension generally indicates greater complexity and heterogeneity. The fractal-based model generation component 216 can then generate a fractal-based model that captures the observed fractal properties of the soil data. This model may involve the generation of synthetic soil property distributions that mimic the fractal characteristics of the actual subsurface. In examples, the fractal-based model generation component 216 can generate multiple CPT-based fractal models, where the model selection component 218 can select a subset of the prior models 124 to provide to the CNN model 114 (FIG. 1) during training. The model selection component 218 can evaluate each fractal model and select one or more fractal models based on one or more factors, such as but not limited to accuracy and fit, generalization, complexity, interpretability, and computational efficiencies.

While depicted as generating fractal-based models, the prior model generator 122 is not limited to generating fractal-based models and can generate different types of models. For example, the prior model generator 122 can generate one or more fractal-based models, principal component analysis (PCA) models, support vector machine models (SVM), linear regression models, or ridge regression models, to name a few examples. In some examples, multiple different types of models can be generated. Thus, in some instances, the prior model generator 122 generates four fractal-based models, one PCA model, and two support vector machine models; alternatively, the prior model generator 122 generates six fractal-based models. The number of models generated by the prior model generator 122 can be a function of or otherwise limited by computing resource availability. For example, six CPT models can be generated. As another example, twelve prior models 124 can be generated. While any number of prior models 124 can be generated (e.g., 100 prior models, etc.), it may be computationally impractical to do so.

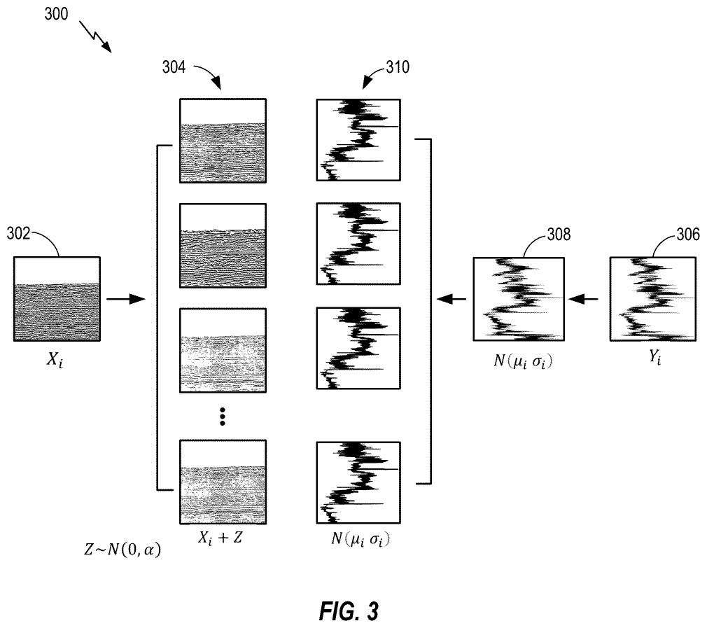

FIG. 3 depicts an example workflow 300 of a training process used for stochastic estimation of subsurface properties. In some aspects, this training process involves the augmentation of seismic data by adding noise and the alignment of seismic data with log data to train a machine-learning model, such as the CNN model 114 of FIG. 1. In some aspects, FIG. 3 depicts how noise can be incorporated into the seismic data and log data, and how the CNN model 114 handles multiple realizations to capture both the variability and uncertainty associated with subsurface properties.

In some examples, the training workflow depicted in FIG. 3 begins with seismic data sample 302, which is then subjected to noise addition, generating multiple noisy versions of the seismic data in 304. In examples, the seismic data sample 302 may be provided from the seismic data 108 of FIG. 1. These noisy versions of the seismic data in 304 may be aligned with log data samples 306. The log data sample 306 may also undergo similar noise augmentation processes, as depicted in 308 and 310. In some examples, the log data sample 306 may be provided from the log data 116 of FIG. 1. This workflow enables the generation of multiple realizations of seismic and log data, helping the CNN model 114 to generalize and improve its ability to predict subsurface properties under various conditions.

In some examples, the seismic data sample 302, labeled Xᵢ, associated with a particular subsurface region. In some aspects, the seismic data Xᵢ, can be high-resolution seismic data or UHR seismic data, which may be used to capture detailed information about subsurface structures. Each sample Xᵢ may represent a matrix of seismic traces that correspond to ground motion measurements collected over a specific period.

In some examples, seismic data Xᵢ is first processed to enhance its quality through pre-processing techniques, such as noise reduction, amplitude normalization, and static corrections, as described in FIGS. 1 and 2 of the present disclosure. Such techniques help the seismic data be more aligned and consistent before introducing noise or augmenting the data for model training.

In some examples, the reference character 304 represents the seismic data sample 302 after noise has been introduced. In some aspects, noise addition is used to augment the seismic data Xᵢ, resulting in multiple noisy versions of the original seismic data, denoted as Xᵢ+Z, where Z represents a noise component sampled from a Gaussian distribution N (0, α). As previously mentioned, this noise augmentation helps to increase the diversity of the dataset and enables the CNN model (e.g., CNN model 114 of FIG. 1) to learn more generalized patterns that better account for the variability found in real-world seismic data.

In some examples, Gaussian noise is applied to the seismic data Xᵢ to simulate the natural variability and potential inaccuracies that may occur during seismic acquisition. By generating multiple noisy seismic data samples, as shown in 304, controlled randomness can be introduced into the training process, thereby improving the CNN model's 114 (as shown in FIG. 1) ability to handle noise and uncertainties in newly acquired seismic data during inference operations.

In some aspects, the log data sample 306 represents a corresponding log data sample Yᵢ, which is used in conjunction with the seismic data to estimate subsurface properties. In some examples, the log data 116 of FIG. 1 can include measurements from CPT or other well log data that provides direct information about subsurface soil and rock properties. Each log data sample Yᵢ may include geotechnical properties such as RES, FRES, and PWP, among others.

The log data sample 306 may provide a set of labeled data points that the CNN model 114 of FIG. 1 uses during training. These labeled data points may be aligned with the seismic data samples (e.g., Xᵢ) to create a dataset that enables the model to map seismic features to corresponding subsurface properties. In some aspects, this alignment of log data with seismic data ensures consistency across different data sources, enhancing the accuracy of the predictions.

In some aspects, the noisy log data 308 represents a log data sample that has been augmented by the addition of noise. In some examples, noise is incorporated into the log data Yᵢ in a similar manner to the noise addition applied to the seismic data. This augmentation results in a noisy version of the log data, denoted as N (μᵢ, σᵢ), where (μᵢ, σᵢ) represent the mean and standard deviation of the log data distribution.

The addition of noise to the log data helps the machine-learning model by allowing it to account for uncertainties and variations in the log data measurements. In some aspects, this noisy log data 308 provides the model with a broader range of training examples, improving its generalization capabilities and reducing the risk of overfitting to specific log data samples.

In some examples, the reference character 310 is directed to multiple noisy realizations of the log data. In some aspects, the log data Yᵢ undergoes multiple rounds of noise augmentation, generating several versions of the log data with varying degrees of noise. This process produces a range of possible values for the subsurface properties, each represented by a different realization of the log data.

By training the CNN model 114 on multiple noisy versions of the log data, as shown in 310, the CNN model 114 of FIG. 1 can be trained to account for the inherent variability in the subsurface environment. This approach allows the CNN model 114 to estimate a predicted value for a given subsurface property and also a distribution of possible values, which can be used to quantify the uncertainty associated with the prediction.

In some aspects, FIG. 3 illustrates a comprehensive workflow for training a machine-learning model using both seismic and log data, each augmented with noise to improve the model's ability to generalize. The example workflow 300 enhances a CNN model's (e.g., CNN model 114 of FIG. 1) ability to predict subsurface properties by exposing it to multiple realizations of noisy data, providing variability and uncertainty in both the seismic data (e.g., seismic data 108 of FIG. 1) and log data (e.g., log data 116 of FIG. 1) sources.

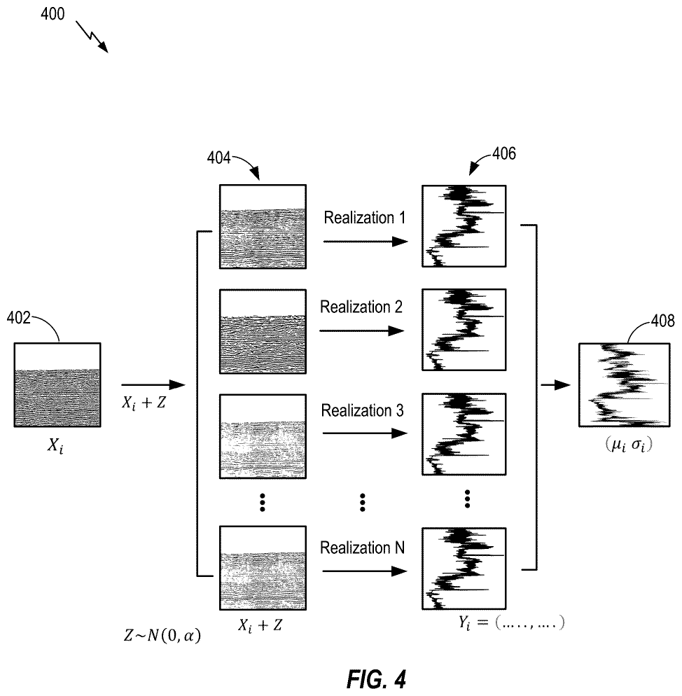

FIG. 4 depicts an example 400 of the inference process (e.g., inference workflow 102 of FIG. 1) for estimating subsurface properties from seismic data using a stochastic approach in accordance with examples of the present disclosure. In some aspects, FIG. 4 depicts how multiple realizations of seismic data samples, along with noise, are processed to generate corresponding realizations of log data. In some aspects, these realizations may provide estimates of subsurface properties along with associated measures of uncertainty. More specifically, the inference process presented in FIG. 4 depicts how seismic data, denoted as Xᵢ, may be augmented with noise, processed through a trained machine-learning model such as the CNN model 114 of FIG. 1, and used to predict subsurface properties Yᵢ, capturing at least one of the variability or uncertainty present in subsurface environments.

In some examples, the process begins with a seismic data sample 402, which is augmented with noise to generate multiple noisy seismic realizations 404. In examples, the seismic data sample 402 may be provided from the seismic data 108 of FIG. 1. In some examples, the process begins with a seismic data sample 402, which is augmented with noise to generate multiple noisy seismic realizations 404. Each noisy seismic realization 404 may be processed to predict corresponding subsurface properties 406, and these multiple predictions may be combined to compute a mean and variance μᵢ, σᵢ, as shown by the data referenced by reference character 408. The mean and variance may provide both an estimate of the subsurface properties and an associated measure of uncertainty.

In some examples, the seismic data sample 402 Xᵢ is processed, as previously described, to ensure that it is aligned with other input data sources, such as structural context models or other geological information. This alignment helps to improve the accuracy of the subsurface property predictions. The each of the noisy seismic realizations 404 may be generated by adding a noise component Z to the original seismic data Xᵢ. In some aspects, the noise Z may be sampled from a Gaussian distribution N(0, α), where a represents the standard deviation or noise level. In some aspects, a series of noisy seismic data samples, Xᵢ+Z, may be generated, each of which simulates potential variations in the seismic data that may occur due to environmental factors or measurement inaccuracies.

A machine-learning model, such as the CNN model 114 of FIG. 1, to predict multiple subsurface properties 406, may then process the noisy seismic realizations 404. That is, the predicted subsurface properties 406, Yᵢ, may be generated from noisy seismic realizations 404. In some aspects, the machine-learning model (e.g., CNN model 114) maps each noisy seismic realization 404 to corresponding predictions of multiple subsurface properties.

Reference character 408 represents the calculation of the mean and variance for the predicted subsurface properties. In some aspects, these statistical measures may be derived from the multiple noisy realizations of the predicted subsurface properties Yᵢ. The mean represents the average predicted value of each subsurface property, while the variance may quantify the uncertainty associated with the predictions.

That is, as previously described, the model (e.g., CNN model 114 of FIG. 1) generates multiple predictions of the subsurface properties, each corresponding to a different noisy seismic realization. By analyzing the spread of these predictions, the posterior distribution for each property can be obtained, capturing both the expected value and the uncertainty. This approach provides not only a single predicted value but also a range of possible outcomes, allowing decision-makers to assess the confidence in the model's predictions.

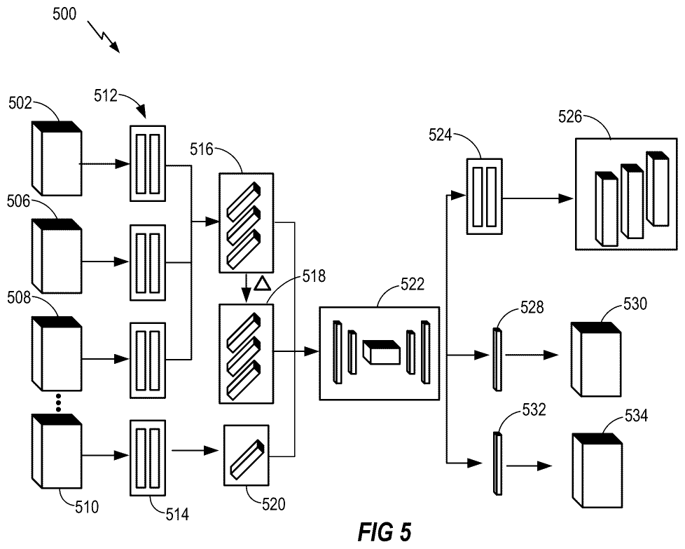

FIG. 5 depicts a multi-task CNN architecture 500 configured to predict multiple subsurface properties from seismic data stacks and additional contextual data in accordance with examples of the present disclosure. In some aspects, the architecture shown in FIG. 5 processes seismic stacks, combining multiple feature maps and passing them through a series of encoder-decoder structures to produce predictions of various subsurface properties such as compressional velocity (Vp), shear velocity (Vs), density (Rhob). This CNN depicted in FIG. 5 may be configured to handle different tasks simultaneously, including both property prediction and uncertainty estimation, by leveraging data from multiple input sources and applying transformations to predict a variety of subsurface characteristics.

The CNN architecture 500 may process input data through various layers for feature extraction, transformation, and output predictions. In some aspects, CNN architecture 500 may receive seismic data inputs 502, 506, 508, and 510, may which represent different seismic data stacks such as near-stack, mid-stack, far-stack, or ultra-far-stack data. These seismic data inputs 502, 506, 508, and 510 may capture seismic traces at various angles or offsets, providing a comprehensive view of the subsurface properties. In some aspects, the seismic data inputs 502, 506, 508, and/or 510 may be the same or derived from the same seismic data.

In some examples, the seismic data inputs 502, 506, and 508 are fed into a feature extraction stage 512, where one or more convolutional layers may detect patterns and relationships within the seismic data inputs 502, 506, and 508. In some examples, this stage generates feature maps that capture relevant aspects of the subsurface structure. For example, seismic data inputs 510 may be provided to one or more convolutional layers in an extraction stage 514 configured to extract relevant aspects of an LSSM, such as the LSSM 128 of FIG. 1.

Following feature extraction, the CNN architecture 500 may include multiple transformation layers 516, 518, and 520. In some aspects, these layers apply convolutional operations to refine the extracted features, capturing both local and global patterns in the seismic data. In some aspects, these transformations may include feature scaling, non-linear activation, and normalization to prepare the features for subsequent analysis. The transformed features may then be passed through an encoder-decoder structure 522. In some examples, the encoder-decoder structure 522 compresses the input features into a lower-dimensional representation before reconstructing them into a higher-dimensional space. This process allows the CNN depicted in FIG. 5 to capture long-range dependencies and deeper structures in the seismic data while retaining beneficial details about the subsurface environment.

In some aspects, the CNN architecture includes multiple prediction branches 524, 526, 528, 530, 532, and 534. Each branch corresponds to a specific output, focusing on predicting different subsurface properties such as compressional velocity (Vp), shear velocity (Vs), density (Rhob), or additional properties like porosity and permeability. In some aspects, these prediction branches 524, 526, 528, 530, 532, and 534 enable multi-task learning, where the CNN model depicted in FIG. 5 may simultaneously predict several subsurface properties from the same seismic input data.

### Example Use Case

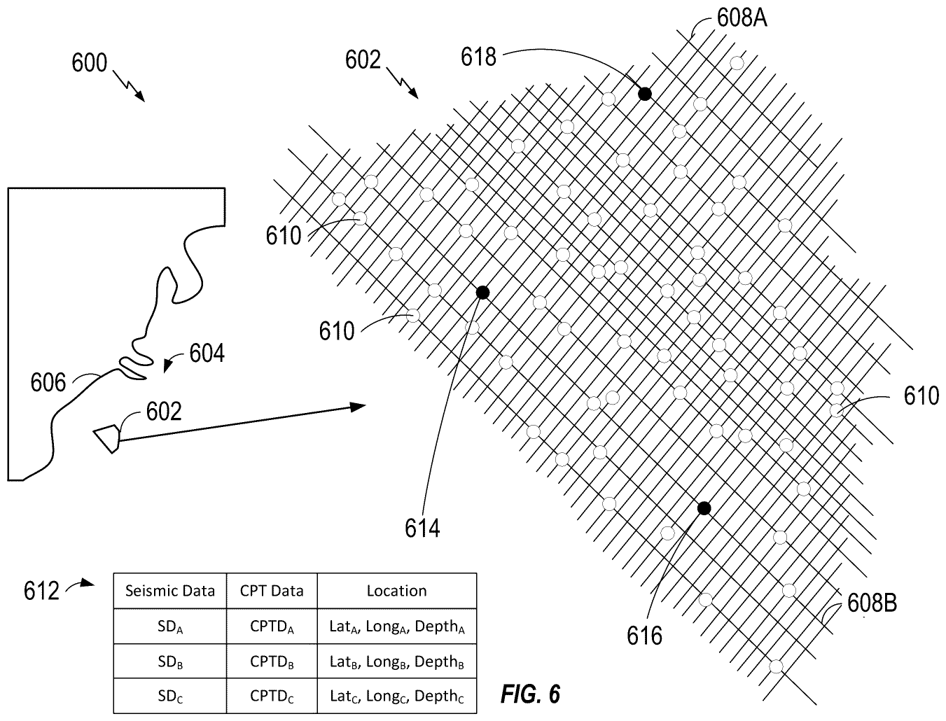

FIG. 6 depicts an example layout 600 of UHR seismic lines and CPT locations at an offshore location 602 in accordance with examples of the present disclosure. In examples, UHR seismic lines form a grid like structure and include a plurality of seismic lines 608A extending in a first direction that are generally orthogonal to a plurality of seismic lines 608B extending in a second direction. Along one or more seismic lines, locations corresponding to CPT sites 610 are depicted. The UHR seismic lines and CPT sites may be for an offshore location 602, where the offshore location 602 is typically within a coastal area 604 and adjacent to a shoreline 606. As depicted in FIG. 6, seismic data and CPT data for a specified location or site can be obtained, and in some examples, may be stored in a data structure 612. The CNN model 114 of FIG. 1 can then be trained (and evaluated) based on the seismic data and CPT data for the same location in a manner as previously described.

As one detailed example, original CPT logs (sampled by 2.5 cm) can be decomposed into mean-variance curves sampled by 12.5 cm to match a seismic sampling rate of the seismic data. Then, six CPT models can be generated at each CPT location. Next, the CNN model 114 can be trained using the UHR seismic data and CPT models (e.g., prior developed or selected CPT models) at a subset of the total CPT locations, such as 58 of 66 CPT locations depicted in FIG. 6. The remaining eight CPT locations can be used for additional testing. Finally, a number of inference operations (e.g., fifty) may be performed using the trained CNN model 114 for estimating the near-subsurface soil properties as well as their associated posterior uncertainty.

### Example Performance Validation Charts

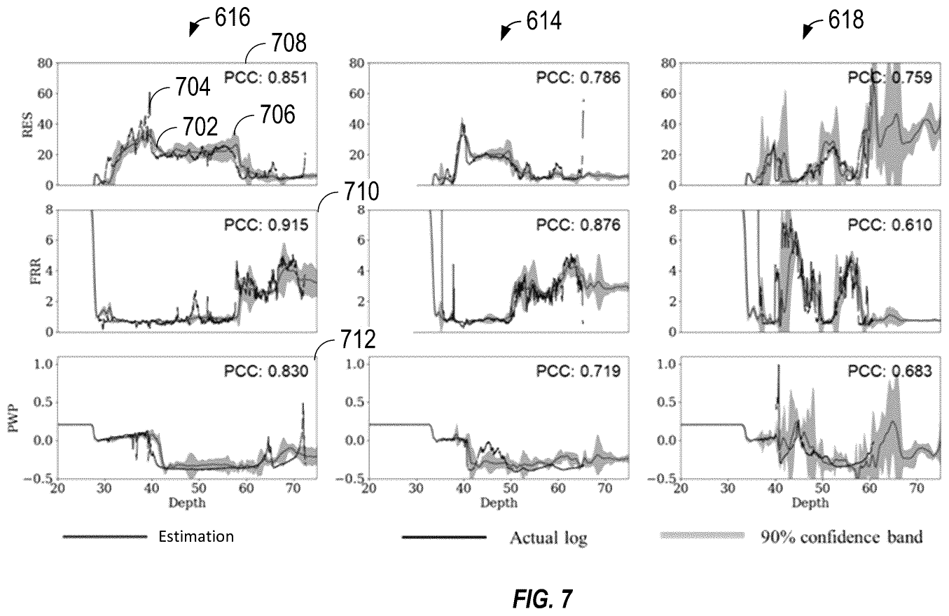

As depicted in FIG. 7, example performance validations using a trained CNN model 114 (FIG. 1) for near-subsurface soil properties at locations 614, 616, and 618 (depicted in FIG. 6) are depicted. That is, as depicted in FIG. 7, the estimated RES 708, derived friction ratio (FRR) 710, and PWP 712 near-subsurface soil properties are depicted generally corresponding to locations 616, 614, and 618 of FIG. 6. For each near-subsurface soil property, a corresponding near-subsurface soil property estimation 702 as predicted from the trained CNN model 114 of FIG. 1, near-subsurface soil property 704 as obtained from log data 116 (e.g., CPT data), and 90% confidence band 706 as predicted from the trained CNN model 114 of FIG. 1 are depicted. In each of the charts, a Pearson correlation coefficient (PCC) may be calculated using the predicted near-subsurface soil property estimation as predicted from the trained CNN model (e.g., 702) and the mean curve decomposed from the actual log data 116 (e.g., CPT data).

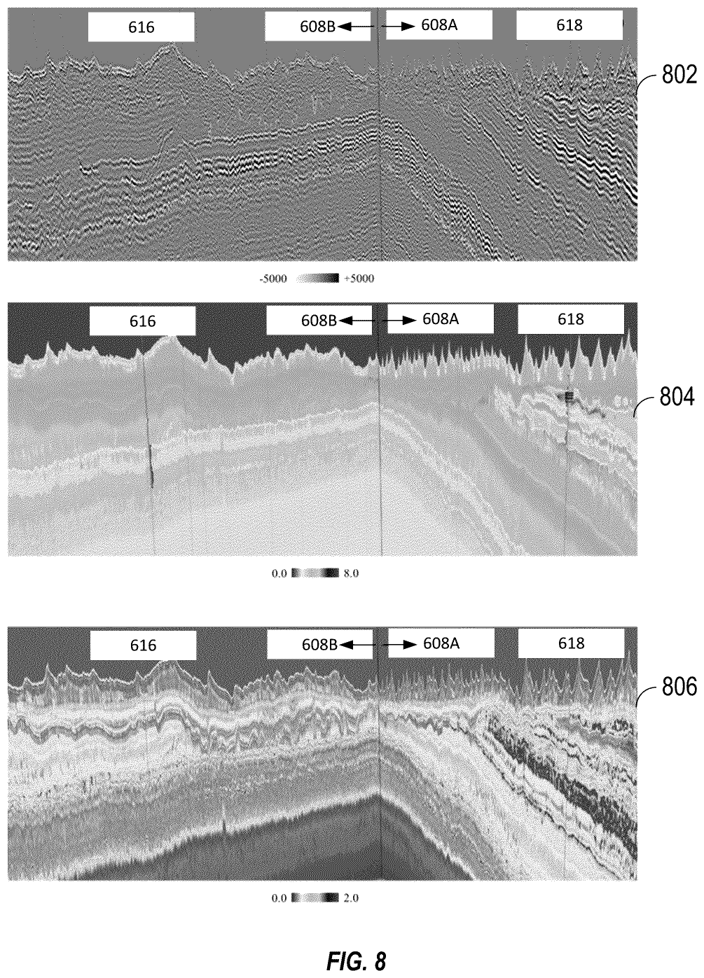

As illustrated in FIG. 8, example CNN model 114 (FIG. 1) predictions along UHR seismic lines are displayed. Image 802 depicts an example 3D view of a UHR seismic line while image 804 depicts predicted FRR using the trained CNN model 114 (FIG. 1) along two crossing seismic lines 608B and 608A. The posterior uncertainty along the two crossing lines as predicted by the trained CNN model 114 (FIG. 1), is displayed in image 806. The predictions of the trained CNN model 114 (FIG. 1) not only matches the actual FRR measurement at both testing CPT locations 616 and 618, but also follows the seismic patterns with good lateral consistency, representing an example of the technical improvement and beneficial effect when utilizing the CNN model 114 (FIG. 1) as described herein to predict near-subsurface soil properties in subsurface environments.

### Example Operations for Performing Stochastic Estimation of a Subsurface Property

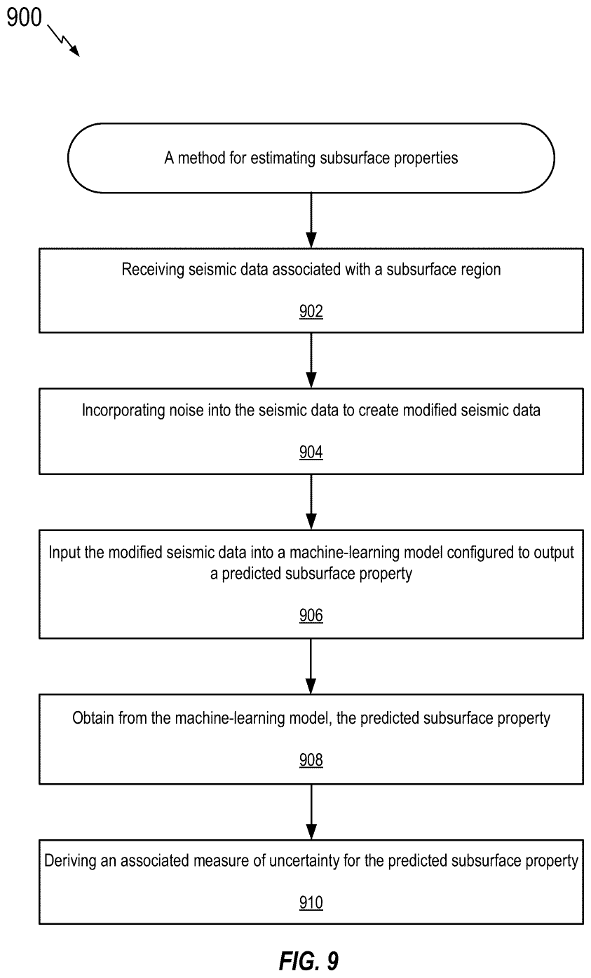

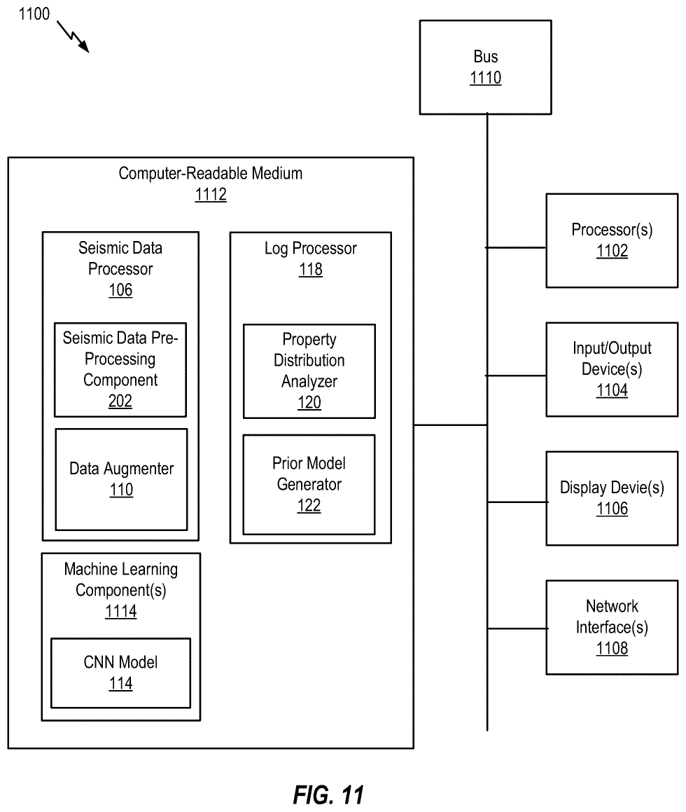

FIG. 9 depicts an example method 900 for performing stochastic estimation of multiple near-subsurface soil properties using a trained machine learning model. Method 900 may be performed by one or more processor(s) of a computing device, such as processor(s) 1102 of processing system 1100 described below with respect FIG. 11.

Method 900 begins at block 902, with receiving seismic data associated with a subsurface region.

Method 900 proceeds to block 904, with incorporating noise into the seismic data to create modified seismic data.

Method 900 proceeds to block 906, with inputting the modified seismic data into a machine-learning model configured to output a predicted subsurface property.

Method 900 proceeds to block 908, with obtaining from the machine-learning model, the predicted subsurface property. In some aspects of method 900, the predicted subsurface property is based on the modified seismic data.

Method 900 proceeds to block 910, with deriving an associated measure of uncertainty for the predicted subsurface property, wherein the predicted subsurface property is associated with the subsurface region.

In some aspects, method 900 further comprises: obtaining structural context data from a large-scale structure model based on the received seismic data; wherein inputting the modified seismic data into the machine-learning model comprises inputting the modified seismic data and the structural context data into the machine-learning model; and wherein the predicted subsurface property is based on the modified seismic data and the structural context data.

In some aspects of method 900, the structural context data represents regional geological features including at least one of fault lines, stratigraphic layers, or folding structures; inputting the modified seismic data into the machine-learning model further comprises combining the modified seismic data with the structural context data as inputs to the machine-learning model; and the predicted subsurface property is based on both the modified seismic data and the structural context data.

In some aspects of method 900, the noise incorporated into the seismic data comprises Gaussian noise.

In some aspects of method 900, the machine-learning model is a machine-learning model trained on seismic data that includes Gaussian noise and a fractal-based model derived from well log data.

In some aspects, method 900 further comprises: decomposing the well log data into mean-variance curves, and generating the fractal-based model based on the mean-variance curves.

In some aspects of method 900, the machine-learning model is a multi-task convolutional neural network (CNN) configured to simultaneously predict multiple predicted subsurface properties.

In some aspects of method 900, the seismic data comprises multiple seismic stacks, including at least two of: near-stack, mid-stack, far-stack, or ultra-far-stack data.

In some aspects of method 900, the method is applied to at least one of: offshore wind farm site selection, hydrocarbon exploration, or a geothermal resource assessment.

In some aspects of method 900, the seismic data includes data from multiple seismic surveys, including at least one of reflection, refraction, or surface wave analysis, and wherein the seismic data is used to capture subsurface structural information.

In some aspects of method 900, the predicted subsurface property includes a rock property, wherein the rock property includes at least one of porosity, permeability, or fracture density.

In some aspects, method 900 further comprises performing a hydrocarbon reserve for a hydrocarbon reservoir based on rock properties.

In some aspects of method 900, the predicted subsurface property includes a soil property, wherein the soil property includes at least one of soil type, compaction, or moisture content.

In some aspects, method 900 further comprises performing a foundation stability assessment based on the soil properties.

In some aspects of method 900, the associated measure of uncertainty for the predicted subsurface property is based on at least one of statistical analysis or probabilistic analysis of the predictions obtained from the machine-learning model.

Note that FIG. 9 is just one example of a method, and other methods including fewer, additional, or alternative steps are possible consistent with this disclosure.

### Example Operations for Training a Machine-Learning Model

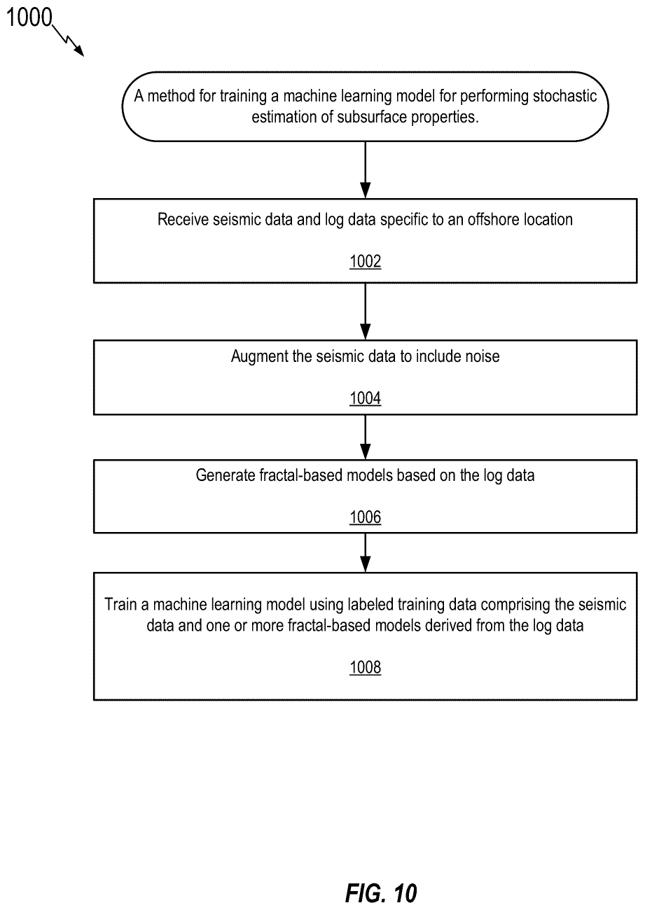

FIG. 10 depicts an example method 1000 for training a machine learning model to perform stochastic estimation of multiple near-subsurface soil properties. Method 1000 may be performed by one or more processor(s) of a computing device, such as processor(s) 1102 of processing system 1100 described below with respect FIG. 11.

Method 1000 begins, at step 1002, with receiving seismic data and log data specific to an offshore location.

Method 1000 proceeds to step 1004, with augmenting the seismic data to include noise. In some aspects of method 1000, the noise is Gaussian noise.

Method 1000 proceeds to step 1006, with generating a fractal-based model based on the log data.

Method 1000 proceeds to step 1008, with training a machine-learning model using labeled training data comprising the seismic data and one or more fractal-based models derived from the log data.

Note that FIG. 10 is just one example of a method, and other methods including fewer, additional, or alternative steps are possible consistent with this disclosure.

### Example Processing System for Performing Stochastic Estimation of a Subsurface Property

FIG. 11 depicts an example processing system 1100 configured to perform various aspects described herein, including, for example, method 900 and method 1000 as described above with respect to FIG. 9 and FIG. 10.

Processing system 1100 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1100 includes one or more processors 1102, one or more input/output devices 1104, one or more display devices 1106, one or more network interfaces 1108 through which processing system 1100 is connected to one or more networks (e.g., a local network, an intranet, the Internet, or any other group of processing systems communicatively connected to each other), and computer-readable medium 1112. In the depicted example, the aforementioned components are coupled by a bus 1110, which may generally be configured for data exchange amongst the components. Bus 1110 may be representative of multiple buses, while only one is depicted for simplicity.

Processor(s) 1102 are generally configured to retrieve and execute instructions stored in one or more memories, including local memories like computer-readable medium 1112, as well as remote memories and data stores. Similarly, processor(s) 1102 are configured to store application data residing in local memories like the computer-readable medium 1112, as well as remote memories and data stores. More generally, bus 1110 is configured to transmit programming instructions and application data among the processor(s) 1102, display device(s) 1106, network interface(s) 1108, and/or computer-readable medium 1112. In certain embodiments, processor(s) 1102 are representative of a one or more central processing units (CPUs), graphics processing unit (GPUs), tensor processing unit (TPUs), accelerators, and other processing devices.

Input/output device(s) 1104 may include any device, mechanism, system, interactive display, and/or various other hardware and software components for communicating information between processing system 1100 and a user of processing system 1100. For example, input/output device(s) 1104 may include input hardware, such as a keyboard, touch screen, button, microphone, speaker, and/or other device for receiving inputs from the user and sending outputs to the user.

Display device(s) 1106 may generally include any sort of device configured to display data, information, graphics, user interface elements, and the like to a user. For example, display device(s) 1106 may include internal and external displays such as an internal display of a tablet computer or an external display for a server computer or a projector. Display device(s) 1106 may further include displays for devices, such as augmented, virtual, and/or extended reality devices. In various embodiments, display device(s) 1106 may be configured to display a graphical user interface.

Network interface(s) 1108 provide processing system 1100 with access to external networks and thereby to external processing systems. Network interface(s) 1108 can generally be any hardware and/or software capable of transmitting and/or receiving data via a wired or wireless network connection. Accordingly, network interface(s) 1108 can include a communication transceiver for sending and/or receiving any wired and/or wireless communication.

Computer-readable medium 1112 may be a volatile memory, such as a random-access memory (RAM), or a nonvolatile memory, such as nonvolatile random access memory (NVRAM), or the like. In this example, computer-readable medium 1112 may include seismic data processor 106, seismic data pre-processing component 202, data augmenter 110, machine learning component(s) 1114 including the CNN model 114, log processor 118, property distribution analyzer 120, and prior model generator 122.

Note that FIG. 11 is just one example of a processing system consistent with aspects described herein, and other processing systems having additional, alternative, or fewer components are possible consistent with this disclosure.

### Example Clauses

Implementation examples are described in the following numbered clauses:
Clause 1: A method for estimating subsurface properties, the method comprising: receiving seismic data associated with a subsurface region; incorporating noise into the seismic data to create modified seismic data; inputting the modified seismic data into a machine-learning model configured to output a predicted subsurface property; obtaining from the machine-learning model, the predicted subsurface property, wherein the predicted subsurface property is based on the modified seismic data; and deriving an associated measure of uncertainty for the predicted subsurface property, wherein the predicted subsurface property is associated with the subsurface region.
Clause 2: The method of Clause 1, further comprising: obtaining structural context data from a large-scale structure model based on the received seismic data; wherein inputting the modified seismic data into the machine-learning model comprises inputting the modified seismic data and the structural context data into the machine-learning model; and wherein the predicted subsurface property is based on the modified seismic data and the structural context data.
Clause 3: The method of Clause 2, wherein: the structural context data represents regional geological features including at least one of fault lines, stratigraphic layers, or folding structures; inputting the modified seismic data into the machine-learning model further comprises combining the modified seismic data with the structural context data as inputs to the machine-learning model; and the predicted subsurface property is based on both the modified seismic data and the structural context data.
Clause 4: The method according to any one of Clauses 1-3, wherein the noise incorporated into the seismic data comprises Gaussian noise.
Clause 5: The method according to any one of Clauses 1-4, wherein the machine-learning model is a machine-learning model trained on seismic data that includes Gaussian noise and a fractal-based model derived from well log data.
Clause 6: The method according to Clause 5, further comprising decomposing the well log data into mean-variance curves, and generating the fractal-based model based on the mean-variance curves.
Clause 7: The method according to any one of Clauses 1-6, wherein the machine-learning model is a multi-task convolutional neural network (CNN) configured to simultaneously predict multiple predicted subsurface properties.
Clause 8: The method according to any one of Clauses 1-7, wherein the seismic data comprises multiple seismic stacks, including at least two of: near-stack, mid-stack, far-stack, or ultra-far-stack data.
Clause 9: The method according to any one of Clauses 1-8, wherein the method is applied to at least one of: offshore wind farm site selection, hydrocarbon exploration, or a geothermal resource assessment.
Clause 10: The method according to any one of Clauses 1-9, wherein the seismic data includes data from multiple seismic surveys, including at least one of reflection, refraction, or surface wave analysis, and wherein the seismic data is used to capture subsurface structural information.
Clause 11: The method according to any one of Clauses 1-10, wherein the predicted subsurface property includes a rock property, wherein the rock property includes at least one of porosity, permeability, or fracture density.
Clause 12: The method according to Clause 11, further comprising performing a hydrocarbon reserve for a hydrocarbon reservoir based on rock properties.
Clause 13: The method according to any one of Clauses 1-12, wherein the predicted subsurface property includes a soil property, wherein the soil property includes at least one of soil type, compaction, or moisture content.
Clause 14: The method according to Clause 13, further comprising performing a foundation stability assessment based on the soil property.
Clause 15: The method according to any one of Clauses 1-14, wherein the associated measure of uncertainty for the predicted subsurface property is based on at least one of a statistical analysis or a probabilistic analysis of the predicted subsurface property obtained from the machine-learning model.
Clause 16: A processing system, comprising: a memory comprising computer-executable instructions; and a processor configured to execute the computer-executable instructions and cause the processing system to perform a method in accordance with any one of Clauses 1-15.
Clause 17: A processing system, comprising means for performing a method in accordance with any one of Clauses 1-15.
Clause 18: A non-transitory computer-readable medium storing program code for causing a processing system to perform the steps in accordance with any one of Clauses 1-15.
Clause 19: A computer program product embodied on a computer-readable storage medium comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for estimating subsurface properties, the method comprising:
receiving seismic data associated with a subsurface region;
incorporating noise into the seismic data to create modified seismic data;
inputting the modified seismic data into a machine-learning model configured to output a predicted subsurface property;
obtaining from the machine-learning model, the predicted subsurface property, wherein the predicted subsurface property is based on the modified seismic data; and
deriving an associated measure of uncertainty for the predicted subsurface property, wherein the predicted subsurface property is associated with the subsurface region.

2. The method of claim 1, further comprising:
obtaining structural context data from a large-scale structure model based on the received seismic data;
wherein inputting the modified seismic data into the machine-learning model comprises inputting the modified seismic data and the structural context data into the machine-learning model; and
wherein the predicted subsurface property is based on the modified seismic data and the structural context data.

3. The method of claim 2, wherein:
the structural context data represents regional geological features including at least one of fault lines, stratigraphic layers, or folding structures;
inputting the modified seismic data into the machine-learning model further comprises combining the modified seismic data with the structural context data as inputs to the machine-learning model; and
the predicted subsurface property is based on both the modified seismic data and the structural context data.

4. The method of claim 1, wherein the noise incorporated into the seismic data comprises Gaussian noise.

5. The method of claim 1, wherein the machine-learning model is a machine-learning model trained on seismic data that includes Gaussian noise and a fractal-based model derived from well log data.

6. The method of claim 5, further comprising:
decomposing the well log data into mean-variance curves, and
generating the fractal-based model based on the mean-variance curves.

7. The method of claim 1, wherein the machine-learning model is a multi-task convolutional neural network (CNN) configured to simultaneously predict multiple predicted subsurface properties.

8. The method of claim 1, wherein the seismic data comprises multiple seismic stacks, including at least two of: near-stack, mid-stack, far-stack, or ultra-far-stack data.

9. The method of claim 1, wherein the method is applied to at least one of: offshore wind farm site selection, hydrocarbon exploration, or a geothermal resource assessment.

10. The method of claim 1, wherein the seismic data includes data from multiple seismic surveys, including at least one of reflection, refraction, or surface wave analysis, and wherein the seismic data is used to capture subsurface structural information.

11. The method of claim 1, wherein the predicted subsurface property includes a rock property, wherein the rock property includes at least one of porosity, permeability, or fracture density.

12. The method of claim 11, further comprising performing a hydrocarbon reserve for a hydrocarbon reservoir based on rock properties.

13. The method of claim 1, wherein the predicted subsurface property includes a soil property, wherein the soil property includes at least one of soil type, compaction, or moisture content.

14. The method of claim 13, further comprising performing a foundation stability assessment based on the soil property.

15. The method of claim 1, wherein the associated measure of uncertainty for the predicted subsurface property is based on at least one of a statistical analysis or a probabilistic analysis of the predicted subsurface property obtained from the machine-learning model.

16. A processing system, comprising:
a memory comprising computer-executable instructions; and
a processor configured to execute the computer-executable instructions and cause the processing system to:
receive seismic data associated with a subsurface region;
incorporate noise into the seismic data to create modified seismic data;
input the modified seismic data into a machine-learning model configured to output a predicted subsurface property;
obtain from the machine-learning model, the predicted subsurface property, wherein the predicted subsurface property is based on the modified seismic data; and
derive an associated measure of uncertainty for the predicted subsurface property, wherein the predicted subsurface property is associated with the subsurface region.

17. The processing system of claim 16, wherein the processor is further configured to cause the processing system to:
obtain structural context data from a large-scale structure model based on the received seismic data;
wherein to input the modified seismic data into the machine-learning model comprises to input the modified seismic data and the structural context data into the machine-learning model, wherein the predicted subsurface property is based on the modified seismic data and the structural context data.

18. The processing system of claim 16, wherein the noise incorporated into the seismic data comprises Gaussian noise.

19. The processing system of claim 16, wherein the machine-learning model is a machine-learning model trained on seismic data that includes Gaussian noise and a fractal-based model derived from well log data.

20. A non-transitory computer-readable medium comprising instructions that, when executed by one or more processors of a computer system, cause the computing system to perform operations for estimating subsurface properties, the operations comprising:
receiving seismic data associated with a subsurface region;
incorporating noise into the seismic data to create modified seismic data;
inputting the modified seismic data into a machine-learning model configured to output a predicted subsurface property;
obtaining from the machine-learning model, the predicted subsurface property, wherein the predicted subsurface property is based on the modified seismic data; and
deriving an associated measure of uncertainty for the predicted subsurface property, wherein the predicted subsurface property is associated with the subsurface region.
